(19) United States
(12) Patent Application Publication
(10) Pub. No.: US 2018/0032996 A1
(43) Pub. Date: Feb. 1, 2018

(54) DATA SHARING WITH CARD ISSUER VIA WALLET APP IN PAYMENT-ENABLED MOBILE DEVICE

(71) Applicant: MasterCard International Incorporated, Purchase, NY (US)

(72) Inventors: Simon Phillips, York (GB); James John Anderson, Brooklyn, NY (US)

(21) Appl. No.: 15/637,747

(22) Filed: Jun. 29, 2017

Related U.S. Application Data
(60) Provisional application No. 62/368,269, filed on Jul. 29, 2016.

(51) Int. Cl. G06Q 20/32; G06Q 20/38; G06Q 20/40; G06Q 20/10; G06Q 20/20

(52) U.S. Cl. CPC G06Q 20/325; G06Q 20/102; G06Q 20/20; G06Q 20/401; G06Q 20/3821

(57) ABSTRACT

A payment-enabled mobile device runs a merchant wallet application. The mobile device engages in a transaction with the merchant at the point of sale. Transaction detail data is transmitted from the wallet application to a transaction authentication server. The transaction detail data includes details of the transaction. A response message from the authentication server is received by the payment-enabled mobile device. Payment credential information is made available to a POS terminal operated by the merchant and/or to a payment processor acting for the merchant.

### CROSS REFERENCE TO RELATED APPLICATION

This application claims the benefit of U.S. Provisional Patent Application No. 62/368,269 (filed on Jul. 29, 2016); the contents of which provisional application are hereby incorporated by reference for all purposes.

### BACKGROUND

FIG. 1 is a block diagram that illustrates a conventional payment system 100.

The system 100 includes a conventional payment card/device 102. As is familiar to those who are skilled in the art, the payment card/device 102 may be a magnetic stripe card, an IC (integrated circuit) card, a fob, a payment-enabled smartphone, etc. The payment card/device 102 is shown being carried and used by an account holder/user 103.

The system 100 further includes a reader component 104 associated with a POS terminal 106. In some known manner (depending on the type of the payment card/device 102) the reader component 104 is capable of reading the payment account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment card issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; (b) tracking and storing transactions and maintaining account records; (c) rendering periodic account statements; and (d) receiving and tracking payments to the issuer from the account holders.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number to the reader component of a POS terminal.

Still further, and as is well-known, for e-commerce transactions, an e-commerce server computer (not shown) may function as the POS terminal. The e-commerce server computer may be operated by or on behalf of a merchant and may be accessed by the account holder via a browser program running on (for example) a personal computer (not shown) or a smartphone (not shown apart from payment device 102). To arrange for the payment portion of the e-commerce transaction, the account holder may manually enter a payment account number, or authorize a charge from a payment account number held on file by the merchant, or access a digital wallet, etc.

The present inventors have now recognized that there are opportunities to improve the payment transaction process, particularly in situations where a payment-enabled mobile device is employed for the transaction, and a wallet application (app) is running on the payment-enabled mobile device.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram that illustrates a conventional payment system.

FIG. 2 is a block diagram that illustrates an embodiment of a payment system provided according to aspects of the present disclosure.

FIG. 3 is a simplified block diagram illustration of a mobile device that may be used in the payment system of FIG. 2.

FIG. 4 is a block diagram that illustrates a computer system that may be a component of the payment system of FIG. 2.

FIG. 5 is a flow chart that illustrates a process that may be performed according to aspects of the present disclosure in the payment system of FIG. 2.

### DESCRIPTION

In general, and for the purpose of introducing concepts of embodiments of the present disclosure, a payment account issuer may perform risk management processing with respect to payment account transactions based on transaction detail data supplied via an internet connection to the payment account issuer (or its stand-in) from a wallet app on a payment-enabled mobile device. The wallet app may have been published, and provisioned to the payment-enabled mobile device, by a merchant such as a large chain of retail stores. In some embodiments, the transaction detail data may include an identification/description of the item(s) to be purchased and/or a price range that indicates the price that is being paid for the purchased item(s). With augmented transaction data thus being made available to the account issuer, the issuer's risk management assessments may exhibit improved reliability and it may be in order to extend improved terms to the merchant relative to the payment account system handling of the transaction.

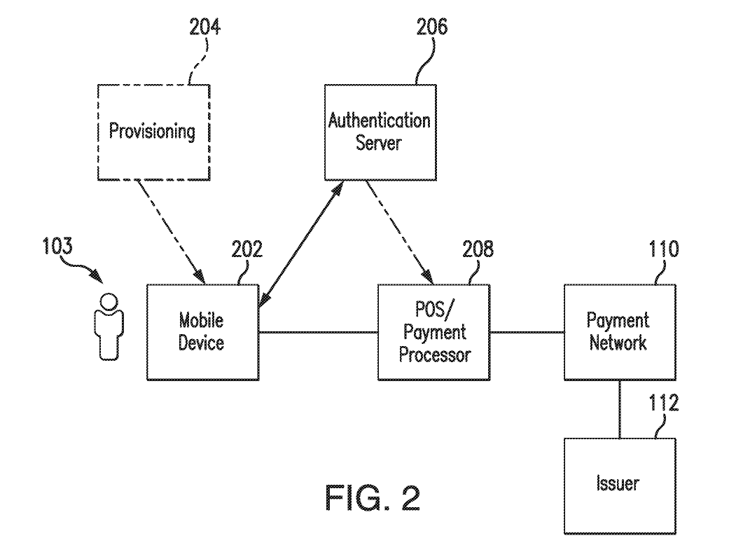

FIG. 2 is a block diagram that illustrates an embodiment of a payment system 200 provided according to aspects of the present disclosure.

FIG. 2 shows a user 103 operating a payment-enabled mobile device 202 (e.g., a suitably programmed smartphone) which performs payment functions in connection with the payment system 200. The user 103 and the payment-enabled mobile device 202 are present at a point of sale, which is not separately indicated in the drawing. It is assumed that the payment-enabled mobile device 202 was previously provisioned with a wallet application (e.g., issued by a merchant) and that one or more payment card accounts have been provisioned to the wallet app. The provisioning of the payment card accounts may have been accomplished via interaction between the mobile device 202 and a provisioning server 204. The provisioning server 204 may act on behalf of one or more payment account issuers and may have performed a suitable ID&V (identification and verification) process before provisioning each payment app to the mobile device 202. The services of a provisioning server like that shown in FIG. 2 are commercially available, for example, via Mastercard Digital Enablement Service (MDES), which is a service offering of Mastercard International Incorporated, the assignee hereof. The wallet app may previously have been downloaded to the mobile device from a merchant website (not shown).

Details of the payment-enabled mobile device 202, and of relevant functionality of one or more apps running thereon, will be described below.

Also shown as part of the payment system 200 is an authentication server 206. The authentication server 206 may authenticate a transaction in response to a request submitted to the authentication server 206 from the payment-enabled mobile device 202. Details of the authentication server 206 and its functionality according to aspects of the present disclosure will be described below.

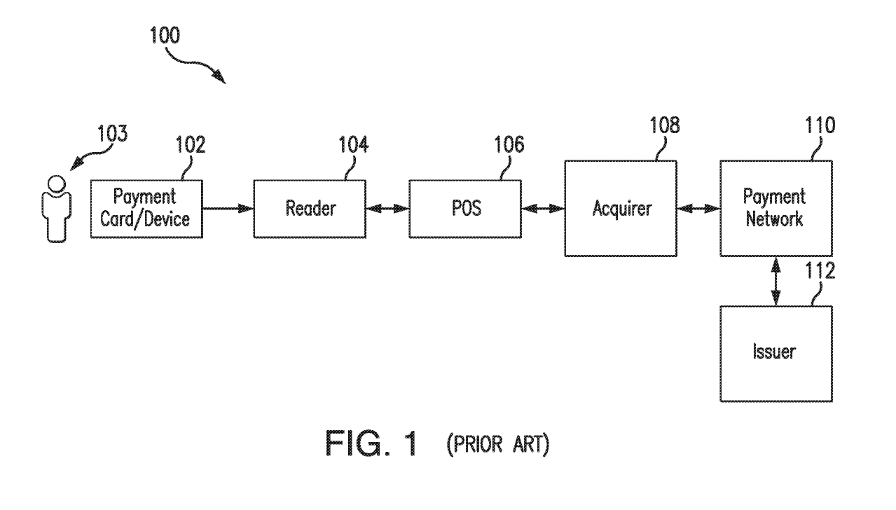

Block 208 is shown in FIG. 2 as representing either or both of a merchant POS terminal (akin to item 106 in FIG. 1) and a payment processor acting for the merchant. The payment processor represented at block 208 may operate on behalf of a transaction acquirer or may be a transaction acquirer like the acquirer 108 shown in FIG. 1.

The system 200 may further include the payment network 110 and issuer computer 112, as referred to above in connection with FIG. 1. The latter two elements may provide essentially the same functionality as in the conventional payment system 100 described above in connection with FIG. 1, although in other embodiments, the issuer computer 112 may be combined or associated with the authentication server 206, and both may be operated by the account issuer.

Alternatively, the authentication server may be operated by an authentication service, which—for example—may be affiliated with the operator of the payment network 110, and retained by the account issuer for purposes described herein.

As shown in FIG. 2, only components of the payment system required for a single transaction are depicted. As noted in connection with FIG. 1, in practical embodiments of the system 200, there may be a considerable number of acquirers and issuers, as well as numerous merchants and many users operating payment-enabled mobile devices. Moreover, other functionality provided by system 200 may accommodate conventional POS and/or online shopping transactions.

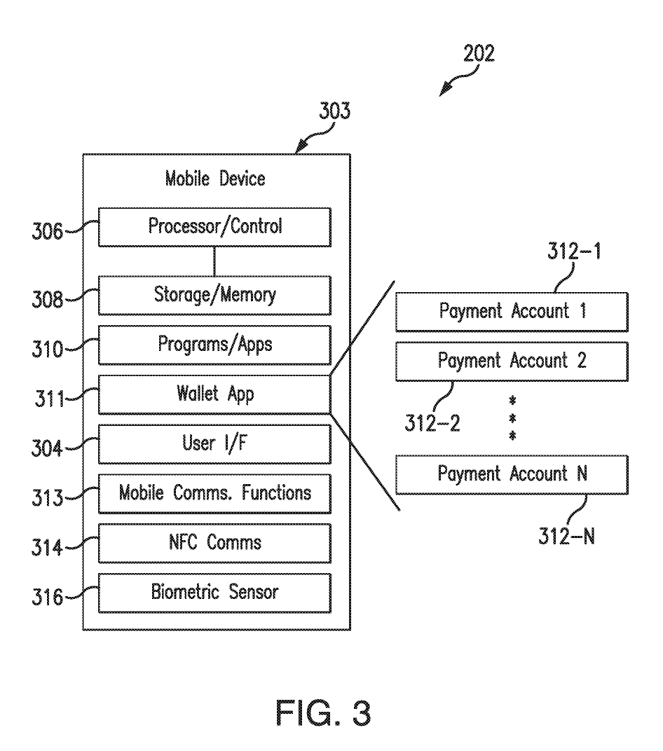

FIG. 3 is a simplified block diagram illustration of the mobile device 202 shown in FIG. 2.

The mobile device 202 may include a housing 303. In many embodiments, the front of the housing 303 is predominantly constituted by a touchscreen (not separately shown), which is a key element of the user interface 304 of the mobile device 202.

The mobile device 202 further includes a mobile processor/control circuit 306, which is contained within the housing 303. Also included in the mobile device 202 is a storage/memory device or devices (reference numeral 308). The storage/memory devices 308 are in communication with the processor/control circuit 306 and may contain program instructions to control the processor/control circuit 306 to manage and perform various functions of the mobile device 202. As is well-known, a device such as mobile device 202 may function as what is in effect a pocket-sized personal computer (assuming for example that the mobile device is a smartphone), via programming with a number of application programs, or “apps”, as well as a mobile operating system (OS). (The apps are represented at block 310 in FIG. 3, and may, along with other programs, in practice be stored in block 308, to program the processor/control circuit 306.)

Also shown in FIG. 3 is a wallet app 311. The wallet app 311 is shown apart from the other apps represented at block 310, in part due to the particular relevance of the wallet app 311 to the subject of this disclosure. In many respects the wallet app may operate with typical functionality of wallet apps that have been previously proposed or deployed, in that through interaction with the wallet app 311, the user may be permitted to select among and access a number of payment accounts (also referred to as payment apps) (reference numerals 312-1, 312-2, . . . , 312-N) that have been provisioned to the mobile device 202 and associated with the wallet app 311.

In some embodiments, the wallet app 311 may have been downloaded to the mobile device 202 by a merchant which the user frequently visits. The wallet app 311 may, for example, be issued by a very large retailer with many stores, and for the purpose of facilitating the user's transactions at the merchant's stores, facilitating offers and advertising to the user, tracking the user's purchases, etc. For present purposes, it is assumed that the point of sale where the user 103 and mobile device 202 are present in FIG. 2 is at one of the retail stores operated by the merchant that issued the wallet app 311

In some embodiments, the wallet app and/or payment account data may be stored in a secure element (SE—not shown apart from block 311, 312 or block 308), which may be provided in some embodiments of the payment-enabled mobile device 202 to provide enhanced security for the payment apps 312 and/or sensitive data associated therewith. The SE, if present, may be conventional in its hardware aspects. In addition or alternatively, security for the payment apps 312 may be enhanced by known alternatives to an SE, such as a TEE (trusted execution environment).

To the extent that the SE includes processing capabilities, it may functionally (though likely not physically) overlap with block 306; to the extent that the SE includes storage (and particularly program storage) capabilities, it may functionally (though likely not physically) overlap with block 308.

While the wallet app 311 may exhibit conventional functionality for apps of that type, it may also provide additional functionality in accordance with aspects of the present disclosure as described herein.

Although several payment accounts 312 are illustrated in FIG. 3, it may alternatively be the case that only one or two payment accounts 312 are associated with the merchant wallet app 311.

As is typical for mobile devices, the mobile device 202 may include mobile communications functions as represented by block 313. The mobile communications functions may include voice and data communications via a mobile communication network (not shown) with which the mobile device 202 is registered.

In addition, to permit the mobile device 202 to emulate a contactless payment card, the mobile device 202 may include short-range radio communications capabilities (block 314), including for example NFC (near field communication). Thus block 314 may represent a suitable antenna (not separately shown) that is appropriate for NFC communications with a POS terminal reader component as well as driving and receiving circuitry associated with the antenna. It will be appreciated that the NFC antenna may be separate and different from the antenna (not separately shown) utilized by the mobile device 202 for the mobile communication functions represented by block 313.

Also shown in FIG. 3 is a biometric sensor 316, which may be one of the components of the payment-enabled mobile device 202. The biometric sensor 316 may be, for example, a fingerprint sensor, and may operate to assist in verifying the user of the device in connection with payment transactions.

From the foregoing discussion, it will be appreciated that the blocks depicted in FIG. 3 as components of the mobile device 202 may in effect overlap with each other, and/or there may be functional connections among the blocks which are not explicitly shown in the drawing. It may also be assumed that, like a typical smartphone, the mobile device 202 may include a rechargeable battery (not shown) that is contained within the housing 303 and that provides electrical power to the active components of the mobile device 202.

It has been posited that the mobile device 202 may be embodied as a smartphone, but this assumption is not intended to be limiting, as mobile device 202 may alternatively, in at least some cases, be constituted by a tablet computer, a smartwatch or by other types of portable electronic devices.

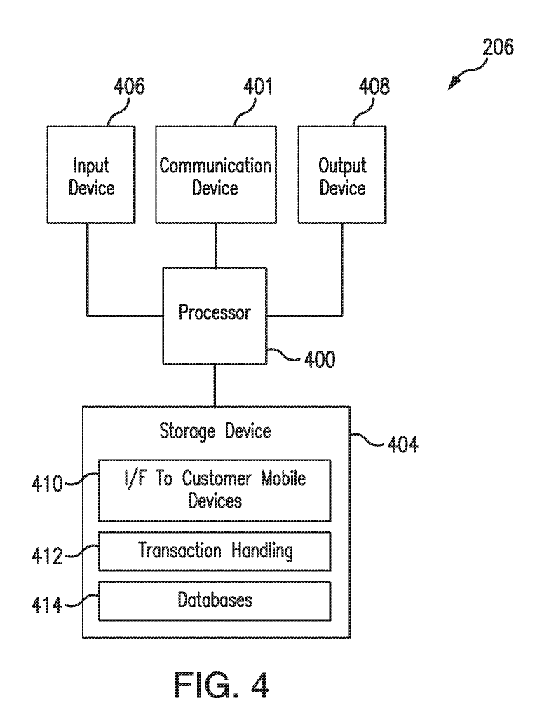

FIG. 4 is a block diagram that illustrates an example embodiment of the authentication server 206 shown in FIG. 2.

Referring now to FIG. 4, the authentication server 206 may, in its hardware aspects, resemble a typical server computer, but may be controlled by software to cause it to function as described herein.

The authentication server 206 may include a computer processor 400 operatively coupled to a communication device 401, a storage device 404, an input device 406 and an output device 408. The communications device 401, the storage device 404, the input device 406 and the output device 408 may all be in communication with the processor 400.

The computer processor 400 may be constituted by one or more processors. Processor 400 operates to execute processor-executable steps, contained in program instructions described below, so as to control the authentication server 206 to provide desired functionality.

Communication device 401 may be used to facilitate communication with, for example, other devices (such as customers' mobile devices). Communication device 401 may comprise numerous communication ports (not separately shown), to allow the authentication server 206 to communicate simultaneously with a number of other devices, including communications as required to simultaneously handle numerous interactions with other devices referred to in connection with FIG. 2.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the authentication server 206, executed by the processor 400 to cause the authentication server 206 to function as described herein.

The programs may include one or more conventional operating systems (not shown) that control the processor 400 so as to manage and coordinate activities and sharing of resources in the authentication server 206, and to serve as a host for application programs (described below) that run on the authentication server 206.

In addition, the storage device 404 may store a software interface 410 that facilitates communication with the mobile device 202 operated by the user 103 and/or other customers' mobile devices.

Still further, the storage device 404 may store a transaction handling application program 412. The transaction handling application program 412 may control the processor 400 so as to enable the authentication server 206 to engage in transaction handling pursuant to requests from customers' mobile devices (e.g., mobile device 202) and in accordance with aspects of the present disclosure. Details of the operation of the authentication server 206 pursuant to the transaction handling application program 412 will be described below.

The storage device 404 may also store, and the authentication server 206 may also execute, other programs, which are not shown. For example, such programs may include a reporting application, which may respond to requests from system administrators for reports on the activities performed by the authentication server 206. The other programs may also include, e.g., device drivers, database management programs, communications software, etc.

The storage device 404 may also store one or more databases (reference numeral 414) required for operation of the authentication server 206.

It should be noted that other computer components of payment system 200, as shown in FIG. 2, may be similar in their hardware architecture and components to the authentication server 206 depicted in FIG. 4.

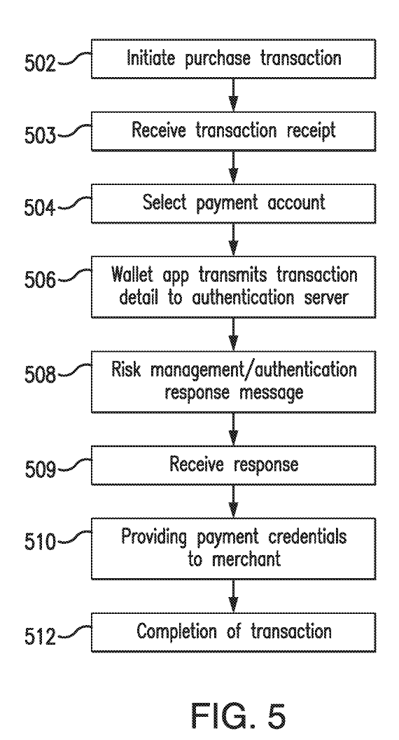

FIG. 5 is a flow chart that illustrates a process that may be performed according to aspects of the present disclosure in the payment system of FIG. 2.

For purposes of the process of FIG. 2, it will be assumed that the user 103 has entered a retail store operated by the merchant that issued the wallet app 311. A further assumption is that the user 103 is carrying the payment-enabled mobile device, as referred to above. It is additionally assumed that while in the store the user 103 has selected one or more items (not shown) that the user desires to purchase and has brought the item(s) to the checkout counter where the merchant's POS device (block 208) is located.

At 502 in FIG. 5, the purchase transaction is initiated in a typical manner, i.e., by using a barcode scanner (not separately shown) or similar device associated with the POS device to scan barcodes on the selected item(s) to input the item identifiers into the POS device. This may be done by the merchant's sales associate, or by the user in the case of a customer-self-checkout point of sale.

The POS device may then calculate a transaction total, sales tax, etc., while also generating an electronic receipt for the transaction. The electronic receipt may include line items that identify the items purchased as well as the price per item. By suitable means, the POS device may communicate the electronic receipt to the wallet app 311 on the payment-enabled mobile device 202. (That is, the electronic receipt may be transmitted from the POS device to the mobile device 202.) Block 503 in FIG. 5 represents the payment-enabled mobile device 202 receiving the electronic receipt from the POS device. For example, the electronic receipt may be displayed by the POS device as a QR code and scanned by a camera component (not shown) of the mobile device 202 as input for the merchant wallet app 311.

At 504, the wallet app 311, via the mobile device user interface 304 (FIG. 3), may prompt the user 103 to select a particular payment account 312 for use in consummating the current transaction. The user may accordingly make a selection among the payment accounts 312 associated with the wallet app 311. In some embodiments, access to the payment account may require a user authentication process, involving for example a biometric measure, e.g., the user presents his/her fingertip to a fingerprint sensor on the mobile device 202 and the user's fingerprint is verified. In some embodiments, only one payment account may be associated with the wallet app 311. Alternatively, if more than one payment account is associated with the wallet app 311, it may be the case that one of the payment accounts has been designated the default account to use with the wallet app 311. In either of these situations, it may be unnecessary for the user 103 to select a payment account for use with the current transaction.

Step 506 may occur once the selected payment app 312 has been opened. At 506, the wallet app 311 transmits transaction data, such as transaction detail data, to the authentication server 206. The transaction detail data may include, for example, data that identifies the product items that are being purchased in the transaction. In some embodiments, the transaction detail data may also include, for each purchased product item, an indicator of a particular price range that represents the purchase price for the product item in question. In this way, it is possible to give the issuer/authentication service a useful indication of the item price without revealing the exact price of the item. It should be understood that each price range may be defined by a respective lower bound monetary amount and a respective upper bound monetary amount. The wallet app 311 may, for purposes of generating the transaction detail data, convert the actual price paid for each item into a price range for the item according to an algorithm included in the wallet app 311.

Transmission of the transaction detail data may occur via communication between the mobile device 202 and the authentication server 206. This communication may, for example, be via a mobile telecommunications network (not shown) and via the internet. In addition to sending transaction data, including transaction detail data, to the authentication server 206, the mobile device 202 may also send other data to the authentication server that may aid the authentication server in its risk management processing. For example, the other data may include the current location of the mobile device, device identification data that uniquely identifies the mobile device, and an indication that user authentication has just been performed with respect to the user 103. The indication that user authentication has been performed may specify that type of user authentication, including fingerprint verification, another biometric measure, and/or PIN entry and verification. It should be noted that the device identification data may be associated with the mobile device during manufacturing or software configuration of the mobile device, and may be different from any payment account number or payment token provisioned to the mobile device or associated with the mobile device.

At 508, the authentication server 206 may perform risk management processing relative to the current transaction. The authentication server 206 may use some or all of the information provided by the wallet app 311 in connection with step 506, as just described. With this information, including product and price range detail, the authentication server 206 may be able to run more reliable and sophisticated risk management algorithms than are typically performed by an account issuer with respect to a transaction. Thus the authentication server 206 may have an enhanced capability for detecting and preventing fraudulent transactions, due at least in part to the transaction detail data shared from the merchant wallet app 311. With this added assurance to the issuer that the transaction is legitimate, the payment transaction may proceed according to terms that are favorable to the merchant relating to factors such as interchange and/or shifting of liability to the issuer in case the transaction ultimately proves to be problematic.

Assuming that the risk management processing so indicates, the authentication server 206 may indicate the transaction is authenticated. This may involve, for example, the authentication server sending a response to the mobile device 202 to indicate authentication and/or the authentication server sending a suitable cryptogram to the merchant POS device or transaction processor (block 208), as the case may be. Block 509 in FIG. 5 represents receiving the authentication server's response at the payment-enabled mobile device 202, e.g., or at the POS device, or otherwise.

Following and in response to authentication of the transaction by the authentication server 206, the payment credentials corresponding to the selected payment account 312 may be provided to the merchant, as indicated by block 510. For example, the wallet app 311 may transmit to the merchant's POS device a payment account number or payment token (plus related information) stored in the mobile device 202. As will be understood by those who are skilled in the art, in arrangements in which the payment credentials are stored remotely from, but accessed via, the payment-enabled mobile device 202, the wallet app 311 may take the necessary action or actions to arrange that the remotely stored payment credentials are provided to the merchant.

In other embodiments, the authentication server may provide, to the POS terminal or the merchant's payment processor, the payment credentials corresponding to the selected payment account 312.

With the payment credentials having been provided to the merchant, the transaction may proceed to completion, as indicated at block 512 in FIG. 5. This may involve issuance of a payment account transaction authorization request, from the POS device or the merchant's payment processor, for routing to the issuer computer 112 via the payment network 110. The issuer computer 112 may issue a payment account transaction authorization response for routing to the merchant. An indication is then provided at the point of sale that the transaction is complete, and the user/customer is permitted to depart the store with the purchased items.

The principles described above with respect to FIG. 5, may also be applied in the context of an online purchase transaction—for example, one in which the user visits the online store maintained by the same merchant that issued the wallet app 311. It is to be understood that in such a case the user may employ the mobile device 202 to access the merchant's online store.

If for some reason the transaction is not completed, then the electronic receipt referred to above may be canceled. For example, the POS device may in such a situation communicate with the payment-enabled mobile device/wallet app to cause the digital receipt to be deleted or marked invalid.

In some embodiments, the merchant wallet app may have only one payment account associated therewith, and the payment account may be “locked” such that the same may be used only for transactions with the merchant that issued the merchant wallet app, or may only be used with a certain group of merchants.

In some embodiments, the authentication server may be operated directly by the issuer of the selected payment account rather than as a service for one or more issuers operated, e.g., by an affiliate of the payment network.

In embodiments described above, payment accounts have been associated with a wallet app in the user's mobile device. The wallet app has been described as communicating transaction data, including transaction detail data, to an authentication server that represents the issuer of a selected payment account. In some embodiments, telecommunication capabilities/features may be associated with each payment account provisioned to the wallet app. In such embodiments, the telecommunication features for the selected account—as provisioned to the wallet app—may be in contact with the authentication server to upload the transaction data/transaction detail data.

In other embodiments, provisioning of payment accounts to the mobile device includes provisioning associated payment apps to the mobile device for association with the wallet app. During a transaction, the wallet app may pass the transaction data/transaction detail data to the selected payment app for the transaction. The selected payment app may transmit the transaction data/transaction detail data to the authentication server.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The above descriptions and illustrations of processes herein should not be considered to imply a fixed order for performing the process steps. Rather, the process steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present invention has been described in connection with specific example embodiments, it should be understood that various changes, substitutions, and alterations apparent to those skilled in the art can be made to the disclosed embodiments without departing from the spirit and scope of the invention as set forth in the appended claims.

What is claimed is:

1. A method of operating a payment-enabled mobile device that runs a merchant wallet application, the wallet application issued by a merchant, the method comprising:
engaging in a transaction with the payment-enabled mobile device at a point of sale;
transmitting transaction detail data via the internet from the wallet application in the payment-enabled mobile device to a transaction authentication server; the transaction detail data including details of said transaction;
receiving a response message at the payment-enabled mobile device from the authentication server; and
in response to receiving the response message, making payment credential information available to at least one of (a) a POS terminal operated by the merchant; and (b) a payment processor acting for the merchant.

2. The method of claim 1, wherein the transmitted transaction detail data includes purchased item details that identify items purchased in the transaction.

3. The method of claim 2, wherein the transmitted transaction detail data includes a respective price range for each purchased item.

4. The method of claim 1, wherein the wallet application transmits to the transaction authentication server, prior to the receiving step, location data that indicates a current location of the payment-enabled mobile device.

5. The method of claim 1, wherein the wallet application transmits to the transaction authentication server, prior to the receiving step, device identification data that uniquely identifies the payment-enabled mobile device.

6. The method of claim 1, wherein the wallet application transmits to the transaction authentication server, prior to the receiving step, an indication that the payment-enabled mobile device has performed a user authentication procedure in connection with the transaction.

7. The method of claim 6, wherein said indication specifies a type of said user authentication procedure.

8. The method of claim 1, further comprising:
prior to said transmitting step, receiving a digital receipt for the transaction, by the payment-enabled mobile device, from a merchant device at the point of sale.

9. The method of claim 8, wherein the payment-enabled mobile device extracts at least some of the transaction detail data from the digital receipt.

10. A method comprising:
receiving, in a computer, transaction detail data from a payment-enabled mobile device; said transaction detail data including details of a transaction engaged in by said payment-enabled mobile device, said details identifying product items purchased in said transaction; and
in response to the receiving step, performing, by the computer, risk management processing based at least in part on said details identifying product items purchased in said transaction, said risk management processing for determining whether to approve the transaction.

11. The method of claim 10, wherein said details include a respective price range associated with each of the identified product items.

12. The method of claim 11, wherein said risk management processing is based at least in part on said price ranges associated with the identified product items.

13. The method of claim 10, further comprising:
in response to a result of the risk management processing, generating a cryptogram by the computer; and
transmitting the cryptogram by the computer to (a) a merchant device associated with the transaction; or (b) a transaction processor associated with a merchant involved in the transaction.

14. The method of claim 10, wherein the risk management processing is based at least in part on at least one of: (i) device identification data received from the payment-enabled mobile device, said device identification data uniquely identifying said payment-enabled mobile device; and (ii) an indication that the payment-enabled mobile device has performed a user authentication procedure in connection with the transaction, said indication received by the computer from said payment-enabled mobile device.

15. The method of claim 14, wherein the risk management processing is based at least in part on said indication that the payment-enabled mobile device has performed a user authentication procedure in connection with the transaction, said indication specifying a type of said user authentication procedure.

16. A method comprising:
transmitting transaction detail data from a payment-enabled mobile device to a remote computer, said remote computer operated by one of: (a) a payment account issuer; and (b) a transaction authentication service; said transaction detail data related to a transaction, said transaction detail data identifying product items purchased in said transaction; and
receiving an indication that the remote computer has authenticated the transaction.

17. The method of claim 16, wherein the transmitted transaction detail data includes a respective price range for each purchased item.

18. The method of claim 16, wherein the payment-enabled mobile device transmits, to the remote computer, prior to the receiving step, device identification data that uniquely identifies the payment-enabled mobile device.

19. The method of claim 16, wherein the payment-enabled mobile device transmits, to the remote computer, prior to the receiving step, an indication that the payment-enabled mobile device has performed a user authentication procedure in connection with the transaction.

20. The method of claim 19, wherein said indication specifies a type of said user authentication procedure.
